(19) United States
(12) Patent Application Publication
(10) Pub. No.: US 2019/0005832 A1
(43) Pub. Date: Jan. 3, 2019

(54) SYSTEM FOR PROVIDING VIRTUAL PARTICIPATION IN AN EDUCATIONAL SITUATION

(71) Applicant: No Isolation AS, Osla (NO)

(72) Inventors: Marius WAAGE AABEL, Oslo (NO); Matias MEISINGSET DOYLE, Oslo (NO)

(21) Appl. No.: 15/736,384

(22) PCT Filed: Aug. 7, 2017
(86) PCT No.: PCT/EP2017/069890

§ 371 Date: Dec. 14, 2017

(30) Foreign Application Priority Data
Aug. 9, 2016 (NO) 20161287

(51) Int. Cl. G09B 5/06; H04N 7/14; B25J 11/00

(52) U.S. Cl. CPC G09B 5/065; H04N 7/147; B25J 11/0015; H04N 7/142; H04N 7/148

(57) ABSTRACT

A system is disclosed providing active participation for persons being prevented to be physically present in educational situations by means of a robot, a server and a personal device providing audio and video from a remote environment to the user, and virtual presence by means of emitting audio from the robot captured by the personal device and providing e.g. movements, mood indications and “raise hand” signals to the robot from the personal device by the user.

### TECHNICAL FIELD

The present invention relates to systems providing active participation for persons being prevented to be physically present in educational situations.

### BACKGROUND

Transmission of moving pictures in real-time is employed in several applications like e.g. video conferencing, net meetings and video telephony.

Video conferencing systems allow for simultaneous exchange of audio, video and data information among multiple conferencing sites. A video conference terminal basically consists of a camera, a screen, a loudspeaker, a microphone and a codec. These elements may be assembled in a stand-alone device for video conference purposes only (often referred to as an endpoint) or it may be embedded in multi-purpose devices like personal computers and Televisions.

Video conference have been used in a variety of applications. It has e.g. been used for remote participation in educational situations, where students follow a lesson or a lecture simply by having established a conventional video conference connection to the auditorium or class room. However, this has a limited presence effect both for the remote participants, and the perception of presence of the remote participants from the point of view of the physically present participants. Some other applications have used robotic tele-presence systems for providing a better remote presence, but these applications have traditionally been adjusted to other purposes than education, e.g. remote medical care and remote industrial maintenance. One example of this is disclosed in the patent publication US20150286789A1. There is a cart including a robot face that has a robot monitor, a robot camera, a robot speaker, a robot microphone, and an overhead camera. The system also includes a remote station that is coupled to the robot face and the overhead camera. The remote station includes a station monitor, a station camera, a station speaker and a station microphone. The remote station can display video images captured by the robot camera and/or overhead camera. The cart can be used in an operating room, wherein the overhead camera can be placed in a sterile field and the robot face can be used in a non-sterile field. The user at the remote station can conduct a teleconference through the robot face and also obtain a view of a medical procedure through the overhead camera.

One example of robotic a tele-presence system that may be used for purposes like education, is disclosed in the patent publication CH709251. Here, a telepresence method for users like sick child in hospital or at home is used, and involves displaying recording of camera of avatar robot on display screen and playing signals received from microphone of robot on loudspeakers. However, the method does not enable the user to control and display video and play audio from a general purpose portable user device which is secured and authenticated as the only access point for the user to the robot, and for the robot only to be controlled by and transmitting media data to the authenticated general purpose portable user device.

US 2007/0192910 relates to autonomous mobile robots for interacting with people, i.e. for assisting people with various tasks. Authorized robots can be permitted by a base station to participate in a trusted network. Such authorized robots have cryptographic or unique identify information which is known to the bae station.

Thus, there is a need for a secure remote presence system for use in class rooms and auditoriums where the most important of the experience and abilities of physical presence are provided also for the remote participants, providing secure authentication of the remote user.

### SUMMARY

In view of the above, an object of the present disclosure is to overcome or at least mitigate drawbacks of prior art.

This object is achieved, in a first aspect, by a system for virtual participation of a user in a remote environment. The remote environment is an environment remote to the user. The remote environment is generally a real environment, i.e. a physical environment. In other words, the remote environment is not a virtual environment. The systems comprising a robot localized in the remote environment, provided with at least one head part and one body part tiltably connected to each other, provided with at least a camera capturing video of the remote environment, a first microphone capturing audio from the remote environment, a first loudspeaker being able to emit audio captured from the user, a wireless connection means adjusted to connect the robot to a wireless network, a processing unit at least adjusted to code and stream video and audio, a Micro Controller Unit (MCU) adjusted to control one or more Motor driver circuits driving one or more electrical motors being able to tilt said head part relative to said body part and to rotate the robot relative to the ground, one or more LEDs for displaying user status and optionally user mood. Optionally, the robot may also comprise a Power Supply circuitry and/or a Battery charger circuitry. The system further comprises a mobile user device provided with at least a second microphone being able to capture user audio, a second loudspeaker being able to emit captured audio from the remote environment and a touch screen being able to display said captured video of the remote environment, an app installed on the mobile user device at least adjusted to transmit an audio stream and control signals and movements commands to the MCU based on user input on said touch screen. In addition the system comprises a server being in communication with said robot and mobile user device, at least adjusted to provide a pairing procedure between said robot and mobile user device, and to authenticate and initiate a direct communication between said robot and mobile user device only if said robot and mobile user device are paired.

In a third aspect, the server is adjusted to, on request from the user, to pair with the robot is adjusted to transmit a randomly generated passcode to the user, and wherein said app is adjusted to prompt the user to enter a passcode and return the entered passcode to the server which is adjusted to pair the app and the robot if the returned passcode equals the randomly generated passcode.

### BRIEF DESCRIPTION OF THE DRAWINGS

FIG. 1 schematically illustrates the overall system,

FIG. 2 is a flow chart illustrating the process of a user device connecting to a paired robot by means of a personal code,

FIG. 3 is a flow chart illustrating the initial pairing process of a user device with a robot,

FIG. 4 illustrates an example of how finger movements on the touch screen may change the captured view by the robot camera,

FIG. 5-7 are schematic views of the different hardware units in the robot and how they interact,

FIGS. 8-10 are illustrations on have events are exchanged between app, robot and server.

### DESCRIPTION OF EMBODIMENTS

In the embodiments herein, systems and methods providing active participation for persons being prevented to be physically present in educational situations are disclosed. A particular situation being addressed is the case where children with long term illness needs assistance to actively participate in the education taking place in a class room. However, the embodiments herein may also be used in other similar situations like remote work, virtual presence for physically disabled people etc. For exemplary purposes, we will in the following description concentrate on class room situations, where a child which is at home or at the hospital is represented by a robot standing on the child's desk at school. The robot works as the child's eyes, ears and voice in the classroom.

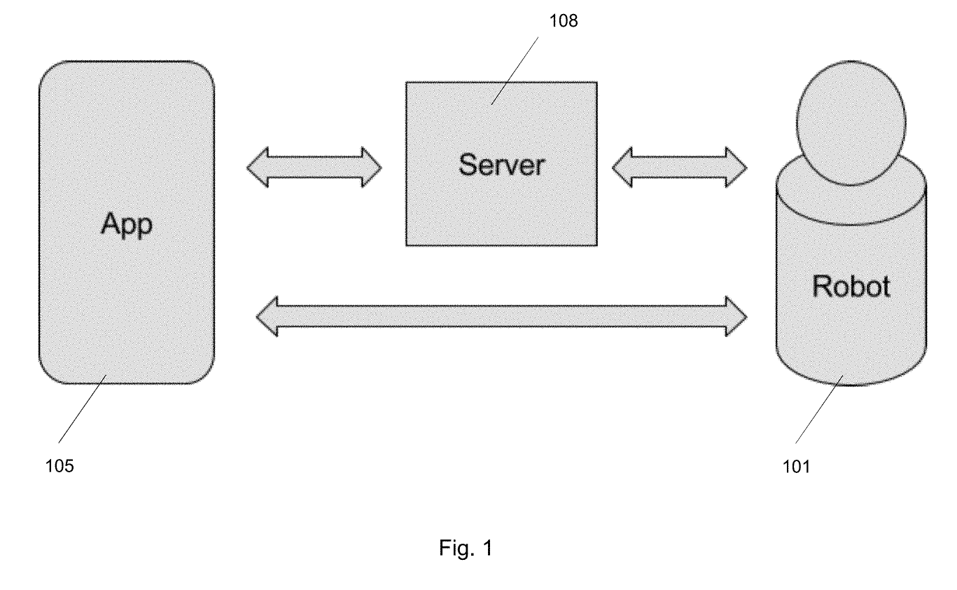

As illustrated in FIG. 1, according to embodiments herein there is a system having three main components: A mobile application (app) being installed on a mobile device with a touch screen, a server system (server), and an avatar robot (robot).

The robot contains means for connecting to a wireless network or a mobile network, e.g. a 4G modem, and uses the mobile network to communicate with the server and the user's app. The robot may in overall be constructed by a head part and a body part which are tiltably connected. The body part could for instance be able to twist the robot 360 degrees in relation to ground. One or more electric drives should be installed providing the abovementioned rotational and tiling movements. The robot could further at least be provided with a camera, a speaker, a microphone, a computer unit and a robotic system.

The server is the glue in communication between the app and the robot. The server is in communication with the robot on a more or less continuous basis, even when the app is not open. When the user of the app opens the app, the app will contact the server and initiate a direct connection between the app and the robot (end to end communication). As will be explained in further details later, this communication will include control signals and video and audio streams.

One important aspect of the embodiments herein is that one robot is securely paired with one personal device (e.g. a mobile phone). Only the paired units are allowed to communicate with each other. This is done to ensure the privacy of the child and the teacher in the classroom.

There will never be any doubt who is logged on to the robot.

Because the robot is paired with one, and only one, mobile phone, a mobile network would be advantageously to use for communication as there would be no configuration to be done on the robot. WiFi would require the robot to be configured for each network it is to be used on.

The mobile app is the tool the children use to interact with their robots. Each robot will only accept connections from one app. Some examples of tasks being performed by the mobile app would be:
Register mobile app against the robot, via a server
Stream audio from the client, receive audio/video from the robot via WebRTC
Send movement commands to the robot
Display the state of robot within the app
Send ‘raise hand’ command
Change volume output on the robot
Express how the child is feeling today

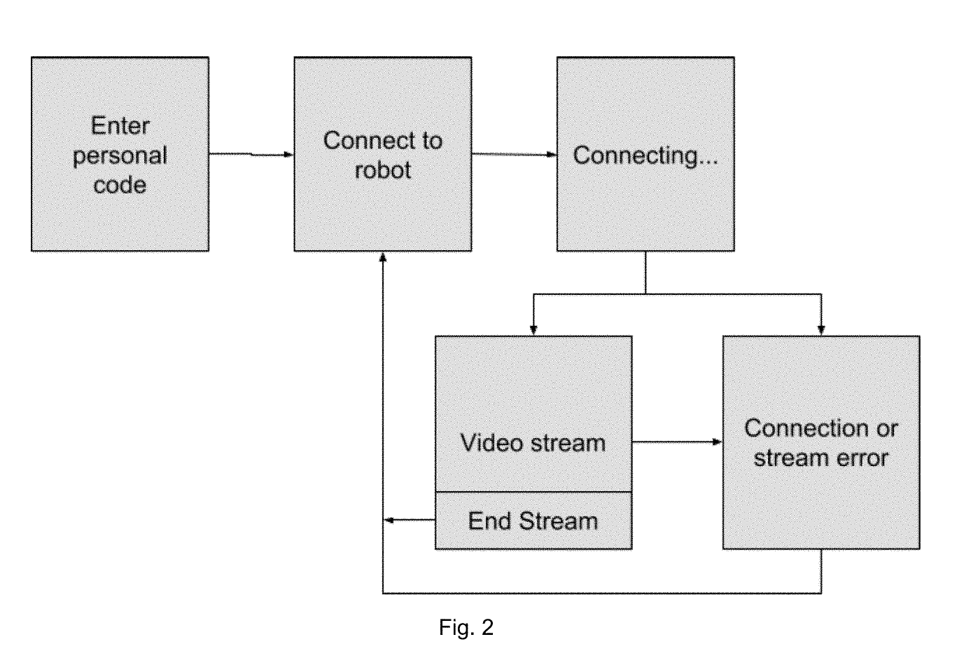

Referring to FIG. 2-4, the abovementioned points will in the following be described in further details.

Register

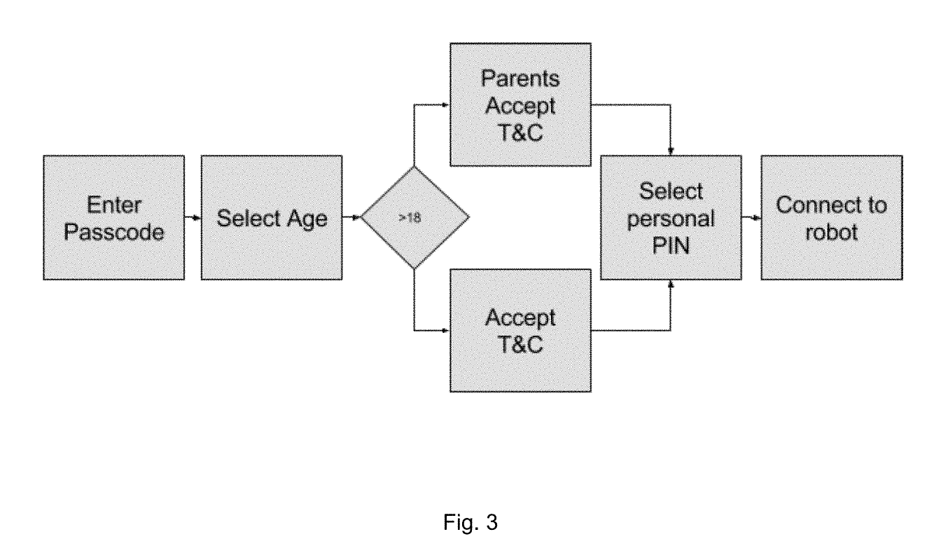

As being illustrated with a flow chart in FIG. 3, when a user sets up a subscription for a robot, he will receive a randomly generated passcode which is used to pair the mobile app with the robot. Because one need to make sure it is only the child that can access the robot, the user must complete multistep process the first time he opens the app. In this registration process, he has to enter the passcode, his age, accept terms (e.g if under 18, parents have to accept), and create a personal code which is used to unlock the app. This is the personal code being referred to in the flow chart of FIG. 2, which illustrates overall connection procedure.

Send Movement Commands

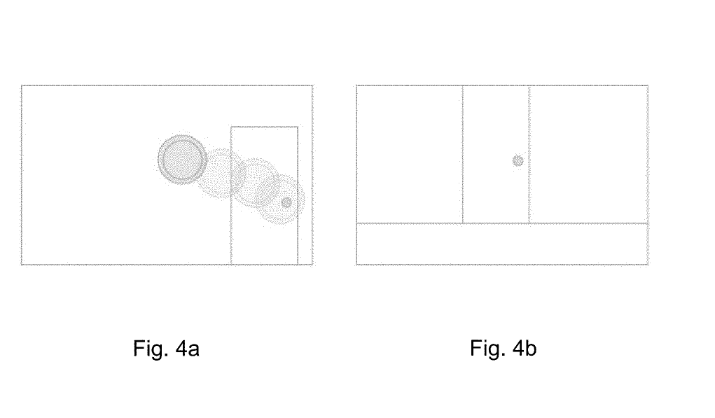

The robot may be controlled by swiping on the screen while the video stream is active, similar to panning on a large image or scrolling on a web page. The picture seen on the user's screen will follow his finger movements. An example of this is illustrated in FIG. 4. The circles in FIG. 4a represent an imaginable movement of the finger on the picture on the touch screen captured by the robot's camera, spanning from a starting circle positioned approximately in the middle of the picture to an ending circle positioned nearby a door handle in the right hand side in the picture. The result of the movement is illustrated in FIG. 4b, where the position of the door handle relative to the picture frame now is positioned approximately in the middle of the picture. This is accomplished by tilt and rotational movements of the head part related to the body part corresponding to the user's finger movement on the touch screen.

State of the Robot

The inventors have experienced that children need to know how their robot looks in the classroom. It is also common in functionality in different video communication applications to have a small image showing how the user virtually appears in other persons view. According to some embodiments, a representation of the robot overlaid the stream. As an example, when a “raise hand” command is sent, a top light starts blinking on the robot. This may be represented in the app by a blinking top light icon appearing on the screen.

Other examples of the state of the robot may be:
On/off state
Small movement animations
Battery status
Emotional colours

Robot Hardware and Software

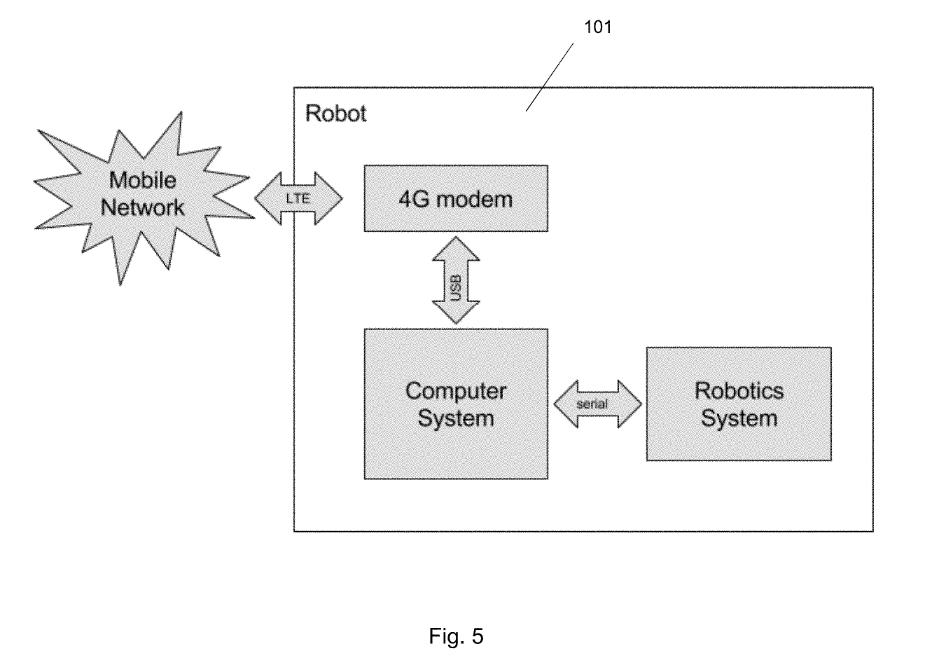

As illustrated in FIG. 5, apart from the mechanics and the robotic system, the robot may have three main units:
Computer unit
Robotics controller (i.e. for movement and indicators)
4G or wireless module

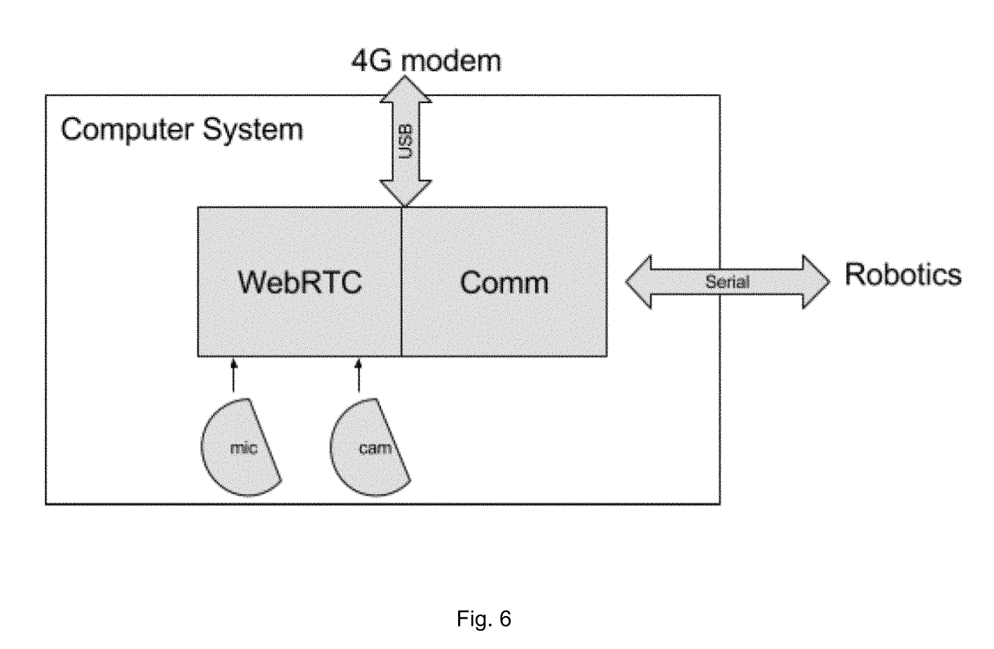

As illustrated in FIG. 6, the computer unit is implemented for handling two main tasks, namely audio/video processing and data communication handling messages and control signaling between the robot systems, the app and server.

The audio/video processing may be implemented in several ways, but in this example, an effective standard method referred to as WebRTC (Web Real-Time Communication) is used. WebRTC facilitates the coding/decoding and streaming of the audio and video data.

The computer unit should preferably be a small embedded computer board which runs the robot's main software connected to the camera, the microphone and the loudspeaker. It is further connected to the 4G modem which enables it to communicate with the mobile app and the server system.

It is also dispatching messages from the app and the server to the Robotics System's Micro Controller Unit (MCU).

Robotics System

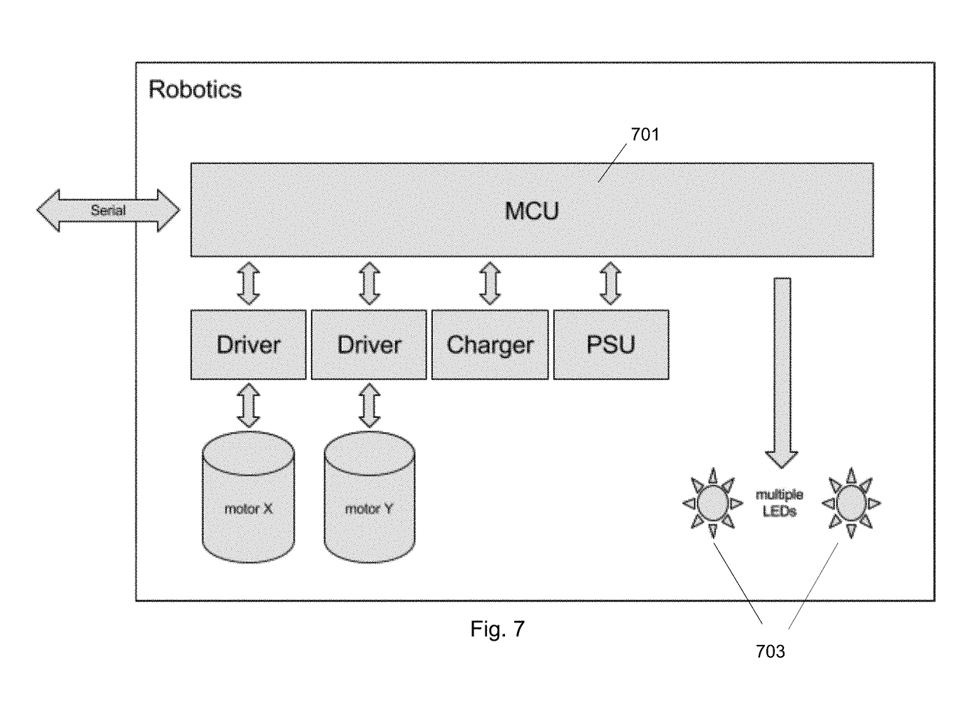

Referring now to FIG. 7, the robotics system may at least comprise a Micro Controller Unit (MCU), Motor driver circuits, 2 stepper motors, LEDs for displaying status and the user's mood, a Power Supply circuitry, and a Battery charger circuitry.

The robot should be able to move in the horizontal and vertical plane.

For horizontal movements, the whole robot turns around. This enables full freedom of rotation, 360 degrees. This is required for the child to look around the whole classroom, even if the robot is placed on a desk in the middle of the room.

For vertical movement, the head part is enabled to tilt up and down relative to the body part. The freedom of tilting movement may be limited, e.g. to approximately 40 degrees to prevent mechanical damages. The camera should be located in the head part, making the user able to look up and down virtually look up and down.

The LEDs may be used to indicate several things:
Robot eyes switched on when the user is connected to the robot
Head light switched on when the user wants to “raise hand”.
Mood lights displaying different colours based on the indicated mood of the user.

Mobile Modem Module

The mobile modem module may be a full GSM (2G), UMTS (3G) and LTE (4G) or another similar next generation mobile modem module used to transfer data between the robot and the app and server. The module may for instance be connected to the AV system via USB to enable high speed data transfer.

Server Systems

The server system communicates with both the robot and the app. When a user wants to connect to the paired robot, it will ask the server if the robot is online, and if so, request it to set up a connection. The connection is then set up between the robot and the app with no data going through the server.

WebSockets

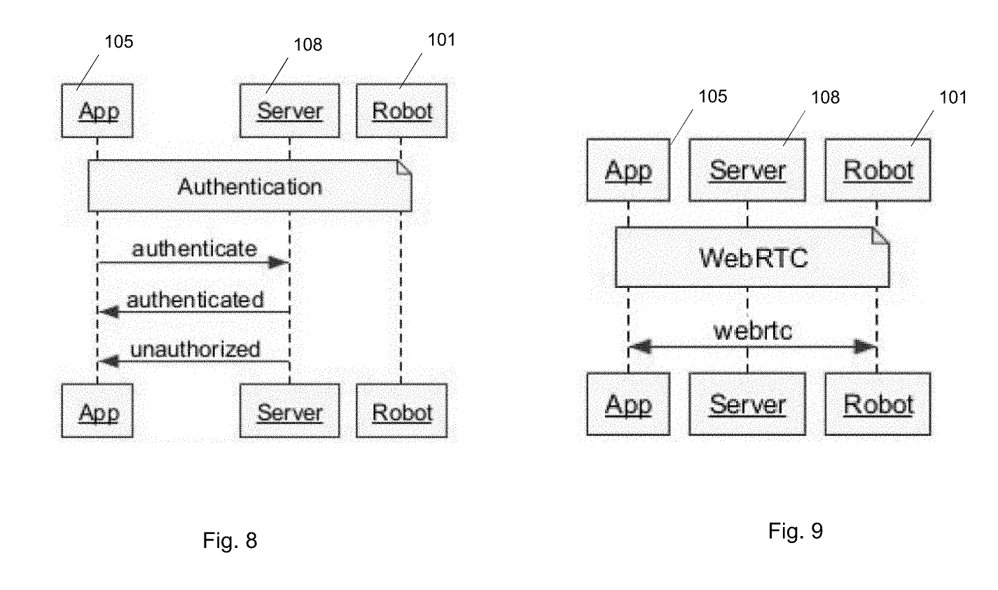

WebSockets may be used as a communication platform between app, robot and server. FIGS. 8-10 are illustrations on have events are exchanged. The system is meant to be flexible so that new events can be added when the software and/or hardware adds more functionality.

Authentication (FIG. 8)

“authenticate” is transmitted from the app after connecting to the server. The event is emitted before any other events are emitted as the server will ignore them until the client is authenticated. A JSON Web Token string containing the login information is sent.

“authenticated” is emitted from server after client successfully authenticates. Empty payload.

“unauthorized” is emitted from server when client fails authentication. Can be emitted at any time, not only after client emits authenticate.

Server disconnects client after emitting.

Webrtc (FIG. 9)

All WebRTC signalling is sent through this event. It takes only one parameter: data. Which should be an object with type and data properties.

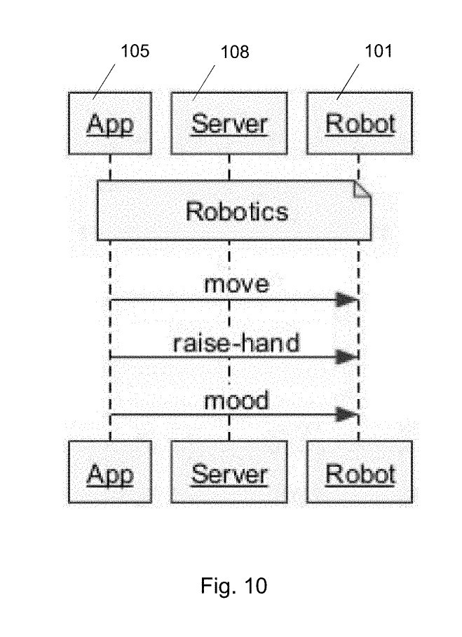

Robotics (FIG. 10)

Robotics commands are broadcast from App to Robot.

Specifications

App Specification

1. WebRTC

a. Send local audio

i. User should be able to mute local audio

b. Receive and display video

i. H264

ii. Video should be displayed full screen

c. Get STUN and TURN servers from communication API

d. Gather statistics about stream quality

i. Aggregated and sent to our stats server

e. Signalling

i. Should emit and listen for signalling events

ii. Messages should be send: {type: String, data: Mixed}

2. Register client

a. User should enter a code when client is not registered

b. Code should be sent to the communication server where the server will reply with a token if code is valid

i. Retrieved token should be stored securely on the device

c. Parents have to agree to terms to not access the stream

d. Child has to create personal code

3. Ensure that child is the person which can access the robot

a. On opening application (after it has been registered) user has to enter personal code

b. If code is valid the user can connect to robot

4. Connect to robot

a. Authenticate client using stored token

b. Should show a connecting screen

5. Attention light

a. Send command to robot

b. Interface/button to send command

6. Movement

a. Send ‘move’ command with touch deltas

b. Tap to move

7. Communicating mood

a. Interface to send mood

8. Change audio level on robot

9. Robot self status (representation of the current state of robot)

a. Battery status

b. Should show which lights are lit and their colour

c. Wake/sleep animations

d. Mood indicator

e. Movement

10. Report errors and exceptions

Robot Hardware Specification
Dimensions
   Weight: <1 kg
   Height: <30 cm
   Width: <20 cm
   Depth: <15 cm
Battery
   Use: >6 h in use
   Standby: >18 h
   Size: 4 cell LiIon,

12 Ah
Voltage: 3.6 or 3.7 V
Power
2 A USB charger
Consumption Use: <1.5 A
Standby: <500 mA
Lights
RGB eyes
RGB top LED
RGB circle of lights on neck or around speaker
Media
8 ohm speaker
Electret microphone
>=5 Mpix camera
Docking station
USB power adapter connects to docking station
Motors
X axis stepper motor, 360 degree free movement
Y axis stepper motor, 40 degree movement
Y axis may need end stop(s)
Real time PCB
ATMEGA328P (may change to NXP or STM ARM M0)
2× motor driver
Amplifier 1.5 W class D
2× step up battery>

5V @ 1 A
1× charger (1.5 A)
USB audio codec
Computer System
SnapDragon on a DART SD410

module
Mobile System
LTE module, one of:
UBlox

TOBI L210
Telit LE910

The above description and illustrations are merely illustrative examples of different embodiments of the present invention, and is not limiting the scope of the invention as defined in the following independent claims and the corresponding summary of the invention as disclosed above.

1. A system for virtual participation of a user in a remote environment, the system comprising:
a robot localized in the remote environment, including at least one head part and one body part tiltably connected to each other, including at least a camera capturing video of the remote environment, a first microphone capturing audio from the remote environment, a first loudspeaker being able to emit audio captured from the user, a wireless connection means adjusted to connect the robot to a wireless network, a processing unit at least adjusted to code and stream video and audio, a Micro Controller Unit, MCU, adjusted to control one or more motor driver circuits driving one or more electrical motors being able to tilt the head part relative to the body part and to rotate the robot relative to the ground;
a mobile user device including at least a second microphone being able to capture user audio, a second loudspeaker being able to emit captured audio from the remote environment and a touch screen being able to display the captured video of the remote environment;
an app installed on the mobile user device at least adjusted to transmit an audio stream and control signals and movements commands to the MCU based on user input on the touch screen, characterized in one or more LEDs for displaying user status; and
a server being in communication with the robot and the mobile user device, at least adjusted to provide a pairing procedure between the robot and the mobile user device, and to authenticate and initiate a direct communication between the robot and the mobile user device only if the robot and the mobile user device are paired.

2. The system of claim 1, wherein the server on request from the user to pair with the robot is adjusted to transmit a randomly generated passcode to the user, and wherein the app is adjusted to prompt the user to enter a passcode and return the entered passcode to the server which is adjusted to pair the app and the robot only if the returned passcode equals the randomly generated passcode.

3. The system of claim 1, wherein the wireless network is a mobile phone network.

4. The system of claim 1, wherein at least one of the LEDs for displaying user status also is adapted to display user mood.

5. The system of claim 1, wherein the robot further comprises a power supply circuitry.

6. The system of claim 1, wherein the robot further comprises a battery charger circuitry.
